(19) United States
(12) Patent Application Publication
(10) Pub. No.: US 2011/0203116 A1
(43) Pub. Date: Aug. 25, 2011

(54) Bolt cutter

(76) Inventor: Frank R. C. Vary, New South Wales (AU)

(21) Appl. No.: 12/656,926

(22) Filed: Feb. 19, 2010

(51) Int. Cl. B26B 17/00

(52) U.S. Cl. 30/187

(57) ABSTRACT

A cutting apparatus used primarily to cut bolts or other cylindrical articles employing a source of compressed air to force a pair ofjaws together. The apparatus includes a handle provided with a trigger and a main body portion including a pair of laterally moving jaws. Compressed air will flow through the handle portion into the main body portion, thereby forcing a diaphragm downward forcing a piston to move in the direction of the jaws. A gear cam would force the proximal end of the jaw assembly outward, thereby forcing the jaws inward against one another, thereby cutting the cylindrical article.

### FIELD OF THE INVENTION

The present invention is directed to a device for cutting a cylindrical object, such as a bolt.

### BACKGROUND OF THE INVENTION

Prior art bolt cutters which consist of a pair of jaws used to cut the bolt traditionally utilized a mechanical lever employing large, heavy handles. Consequently, a large mechanical advantage was required to force the jaws together. This type of bolt cutter required a considerable amount of effort to operate and to properly manipulate the cutter to adequately cut the bolt.

Prior art devices such as U.S. Pat. No. 5,599,227, which issued to the applicant, describe a cutting device suitable for animal dehorning which employs a pneumatically powered device. However, this device included a pair of blades, one of which moved downward to a second blade to dehorn the animal. Additionally, this device did not include a trigger mechanism attached to a handle to properly control the operation of the device.

### SUMMARY OF THE INVENTION

The deficiencies of the prior art are addressed by the present invention which is directed to a pneumatically operated bolt cutter which is lightweight, portable and can easily be operated. The bolt cutter includes a handle portion removably connected to a source of pressurized air at a constant pressure such as 120 PSI. Various fluid passageways in the handle would be utilized to introduce the pressurized air to the bolt cutter as well as to exhaust the air from the bolt cutter after use. A trigger provided in the handle portion is used to initiate the operation of the device. The handle is connected to a main body portion including a diaphragm, a piston and a gear cam used to force two laterally positioned jaw blades together, allowing a bolt positioned between the jaws to be cut.

The compressed air is introduced into the main body portion when the trigger is engaged and would force a diaphragm downward, requiring the piston to move toward the gear cam which in turn would force the jaw blades together. Once the bolt is cut, the trigger would be disengaged, and the compressed air in the main body would exit the bolt cutter through the handle portion. The piston would move back to its original position, thereby forcing the jaws open, allowing the bolt cutter to be reset for another cutting cycle.

### BRIEF DESCRIPTION OF THE DRAWINGS

The present invention will be more fully understood by reference to the following drawings which are for illustrative purposes only and wherein like reference numerals would be utilized for like parts.

FIG. 1 is a perspective view of the bolt cutter of the present invention;

FIG. 2 is a side view of the bolt cutter shown in FIG. 1;

FIG. 3 is a top view of the bolt cutter shown in FIG. 1;

FIG. 4 is a perspective view of the front portion of the bolt cutter shown in FIG. 1;

FIG. 5 is a top view of the internal mechanism of the present invention;

FIG. 6 is a side view of the internal mechanism of the present invention;

FIG. 7 is a top view of the interior of the handle portion;

FIG. 8 is a perspective view of a portion of the handle mechanism shown in FIG. 7;

FIG. 9 is a perspective view of a handle portion shown in FIG. 7 with the trigger depressed;

FIG. 10 is a portion of the internal mechanism of the present invention showing the jaws prior to being closed;

FIG. 11 is a top view of a portion of the internal mechanism of the present invention showing the jaws in a closed position; and

FIG. 12 is a top view showing the manner in which compressed gas exits the present invention.

### DETAILED DESCRIPTION OF THE PRESENT INVENTION

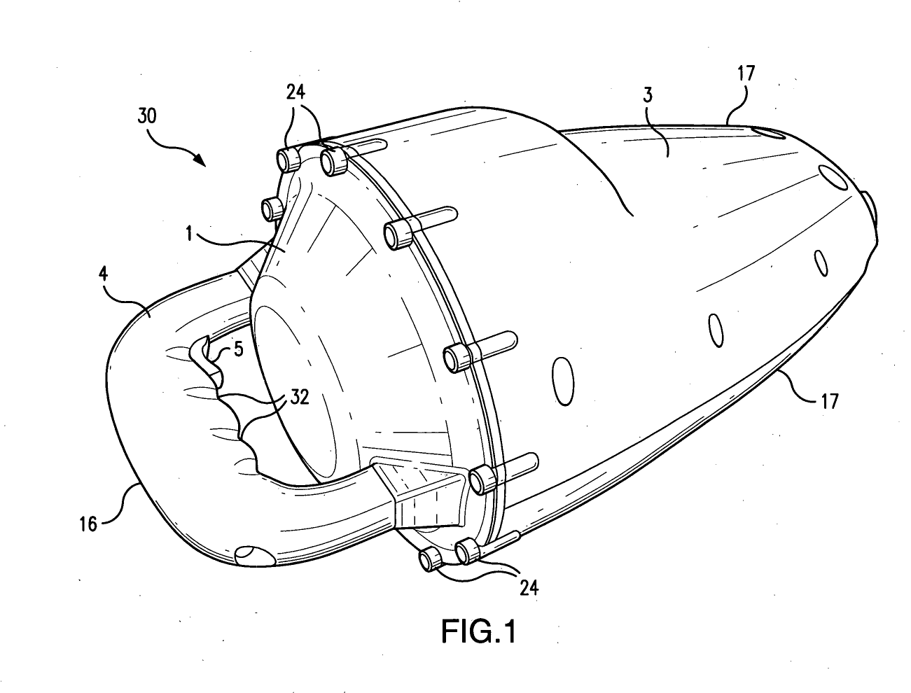

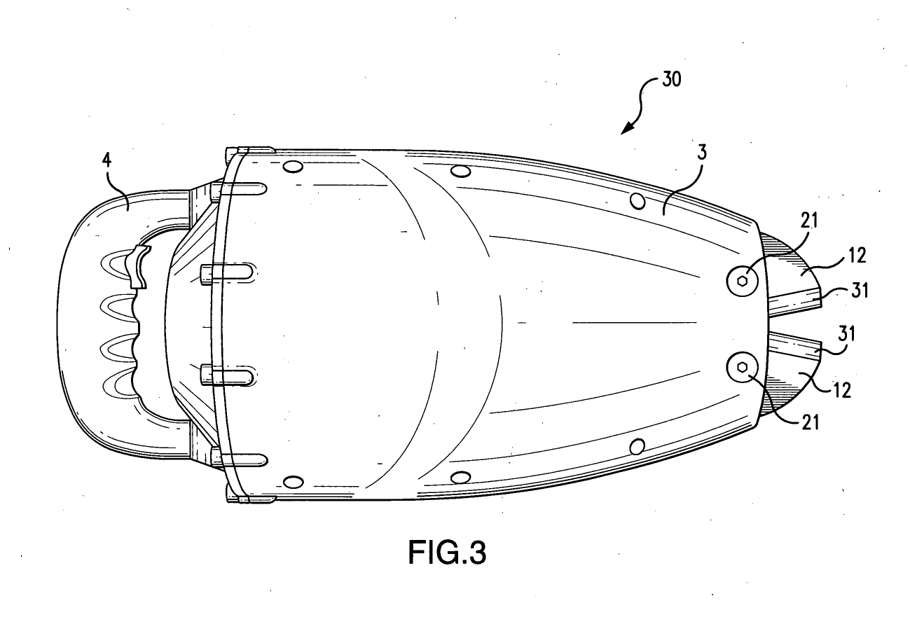

FIGS. 1-4 illustrate the present exterior configuration of the present invention 30. This configuration includes two subassemblies designated as a handle portion 4 and a main body portion 3. The main body portion also includes an end cap 1 to which the handle portion 4 is directly attached and two opposed main body covers 17. The handle portion 4 includes a handle cap 16 comprising two identical body portions which are attached to one another by a plurality of screws, bolts or similar attachments. Two jaws 12, each having a cutting surface 31 extend from the distal end of the main body portion 3.

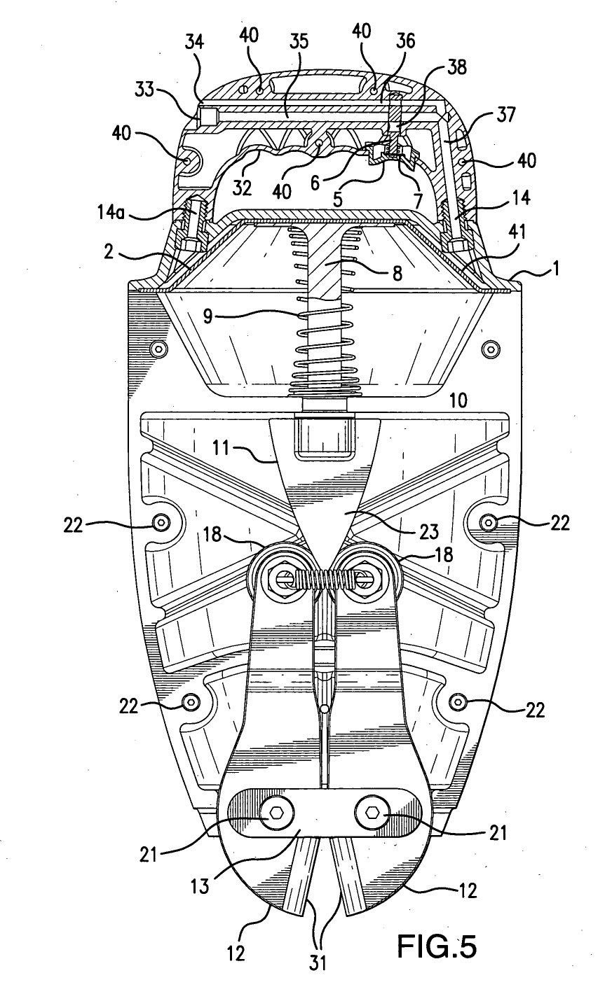

Reference is now made to FIG. 5 in which a plurality of holes 40 are shown through which the attachment devices would pass, thereby securing the two halves of the handle portions together. The handle portion includes a trigger mechanism 5 attached proximate to a grip portion 32 having a number of indentations allowing an individual's fingers to grasp and hold the handle cap 16. The trigger mechanism includes a valve 6 moving within a cylinder 44, a spring 39 and a valve pin 7. As will be subsequently explained, the interior of the handle 4 would be provided with a plurality of air flow passageways allowing compressed air to enter the bolt cutter as well as to be exhausted from the bolt cutter. The end cap 1 which is directly attached to the handle 4 is secured to the main body portion 3 by a plurality of bolts or screws 24. The compressed air will pass through air passageways connecting the interior of the handle 4 to the interior of the end cap 1. Two screws 14 and 14a are used to secure the handle cap 16 to the end cap 1. One of the screws 14 has been modified to also act as a passageway for the compressed air.

The main body portion 3 comprises two similarly configured main body covers 17 which form the top and bottom of the main body assembly 3. These main body covers 17 are secured to one another by a plurality of shoulder bolts 22 as also shown in FIG. 5. Although the composition of the end cap 1, main body 3 and handle 4 are not crucial to the present invention, these exterior pieces can be constructed form a lightweight, but durable plastic material.

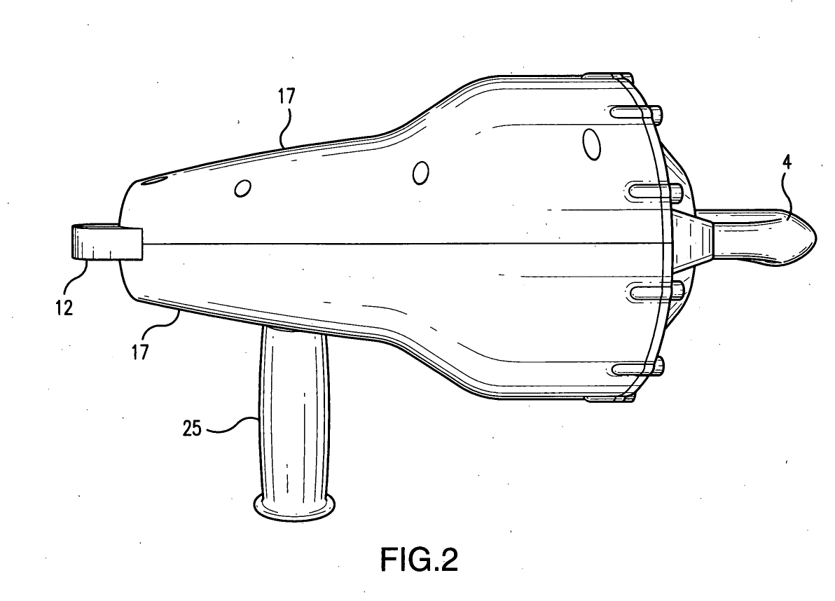

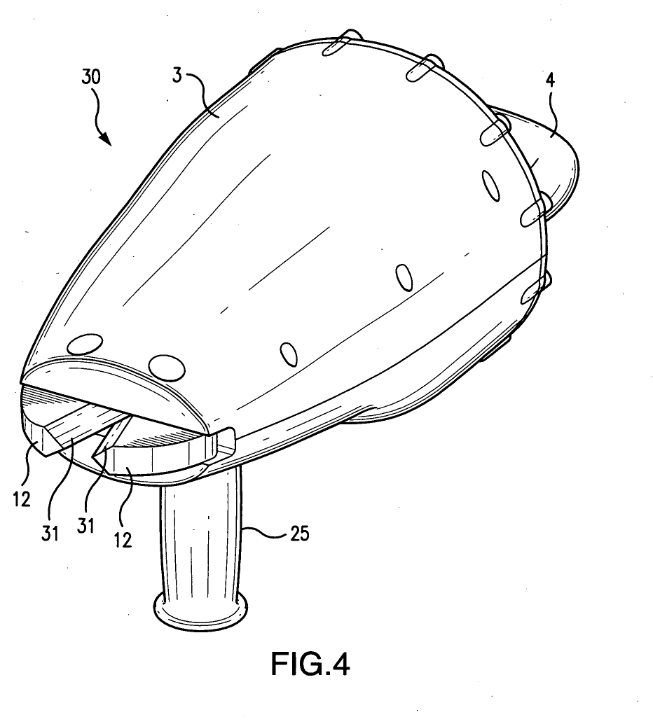

As shown in FIGS. 2 and 4, a support handle 25 is directly affixed to one of the main body covers 17. The purpose of this support handle 25 is to allow the operator a secure hold when the two jaws 12 which extend from the main body portion 3 would laterally move together allowing a blade portion 31 provided on each of the jaws 12 to cut a bolt or similarly configured cylindrical piece.

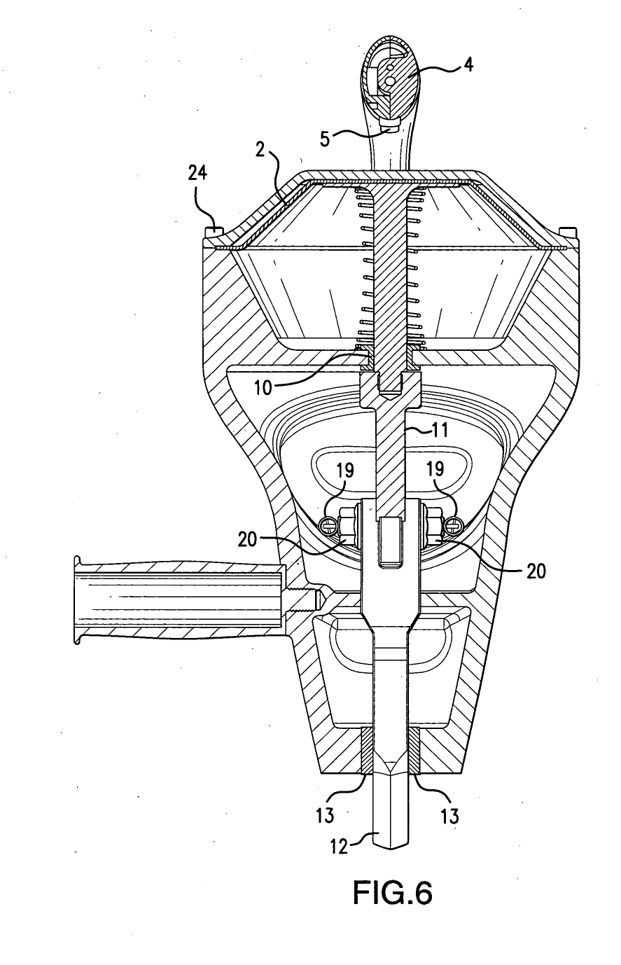

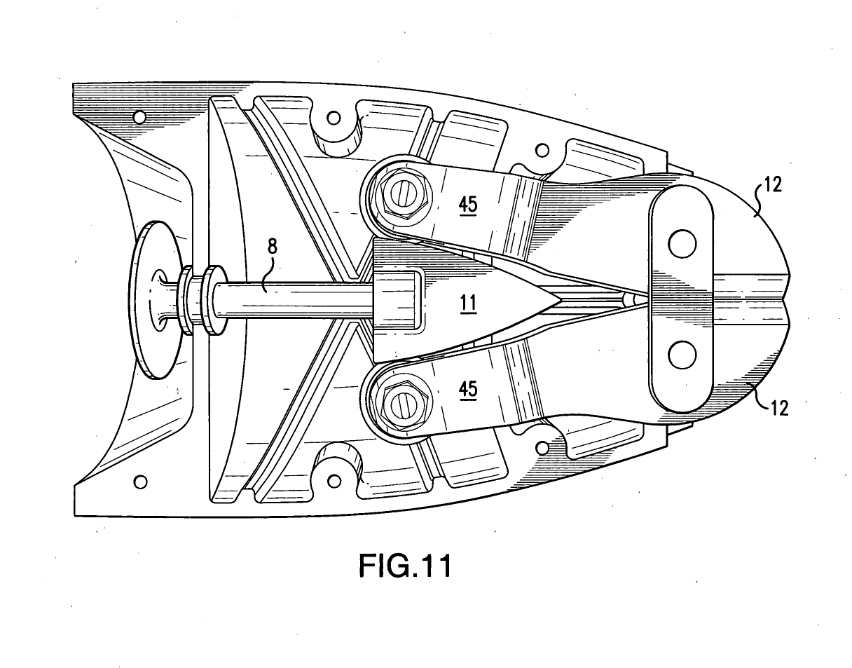

Reference is now made to FIGS. 5 and 6 which illustrate the interior of the bolt cutter. As shown in FIG. 5, an interface 33, such as a ⅜″ BSP allows compressed air produced from a source (not shown) to be introduced into the handle 4 of the bolt cutter. The interface 33 is connected to air passageways 35 and 37 allowing the compressed air to travel to the modified socket head screw 14. Compressed air would then exit the screw 14 and would be directed into a chamber 41 provided between the end cap 1 and a diaphragm 2. An exhaust passageway 36 extends between air passageway 37 and an exhaust orifice 34. The diaphragm 2 is held in position as a result of being pinched by the end cap 1 and a combination of the main body 3 and the main body cover 17. As shown in FIG. 5, prior to the bolt cutter being activated, the jaws 12 are biased in the open position through the use of a spring 9 surrounding a piston 8 as well as two springs 15. A gear cam 11 having a distal wedge 23 is threadedly attached to the piston 8 and a pin bushing 10 is provided therebetween. The piston 8 would move up and down the piston bushing 10 which is also held in place by the main body 3 and the main body covers 17. Once sufficient compressed air enters the chamber 41 and spreads across the surface of the diaphragm 2, the piston 8 would be forced toward the gear cam 11. The distal wedge 23 could then move between the proximal portion jaw assemblies 45, forcing these assemblies open, thereby closing the jaws 12 as shown in FIG. 11.

The gear cam 11 is designed so that the pressure angle changes and decreases the further it is forced toward the jaws 12, allowing the reduction in the amount of energy required to close the jaws. The taper of the jaw's cutting faces or blades 31 allows that the further that they cut into a cylindrical rod or bar, the greater the surface area that they would have to work against. This would increase the resistance and therefore the requirement for a drop in the pressure angle, the further the jaws would travel in the lateral motion toward one another. The gear cam wedge 23 would move toward the jaws 12 through a pair of roller bearings 18 which would each pivot around individual bearing pins 19 (see FIG. 6). Each of the bearing pins 19 is held in place by separate flanged nuts 20. Each of the jaws 12 are attached to the main body 3 and the main body covers 17 through the use of separate shoulder bolts 21. These shoulder bolts 21 pass through a pair of jaw braces or straps 13 (only one of which is shown) which are used to strengthen, support and guide the jaws' motions as they move toward or away from one another.

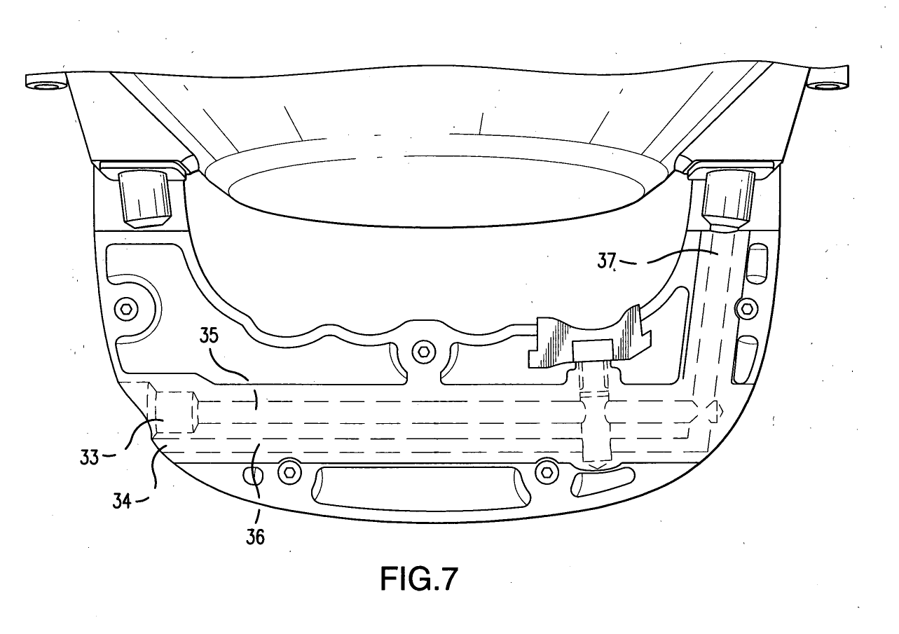

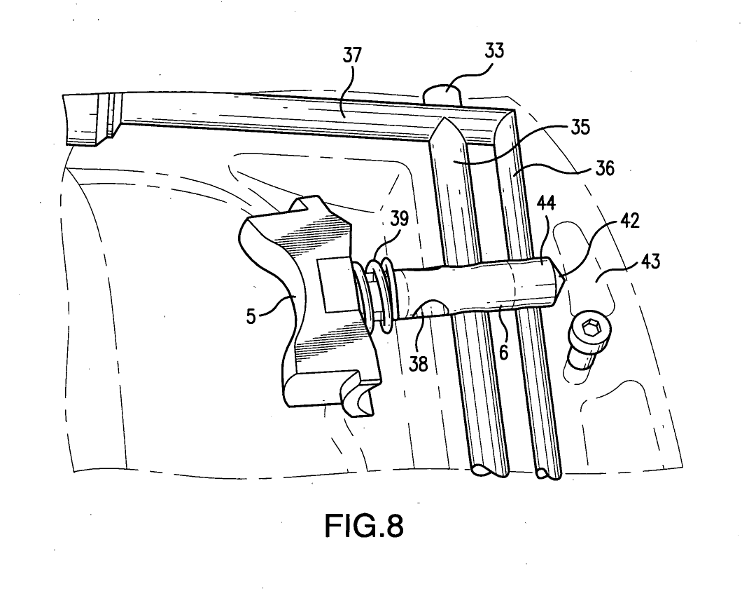

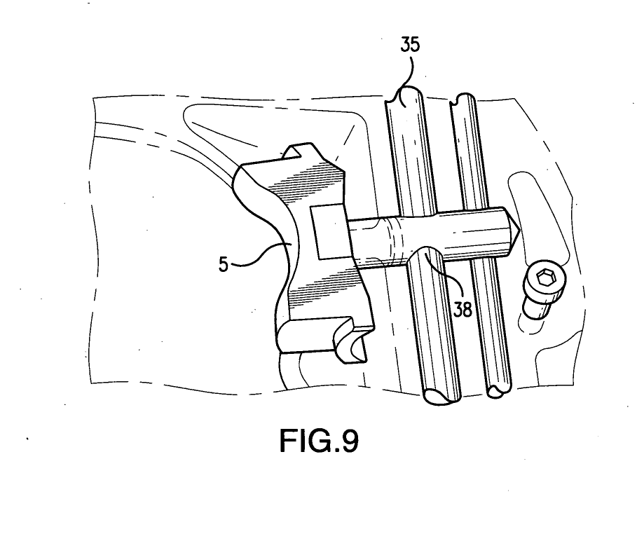

As shown in FIGS. 7 and 8, the trigger 5 is provided with a spring 39 as well as an orifice 38 extending through the valve 6. It is noted that the valve 6 moves within the cylinder 44. The cylinder 44 is provided with a pointed end 42 and an abutment 43 is provided beyond the pointed end 42. Although the cylinder 44 is not designed to move, if this does occur, the abutment 43 will prevent any further movement. As shown in FIG. 8, when compressed air enters the passageway 35 through inlet 33, it cannot travel beyond the valve 6 and into passageway 37 until the trigger 5 has been depressed. Once this occurs as shown in FIG. 9 with the orifice 38 in line with the passageway 35, the compressed air would move through passageway 37 and then through the screw 14. Since the valve 6 is in the position shown in FIG. 9, the compressed air cannot move through the exhaust passageway 36 and cannot therefore exit the exit orifice 34.

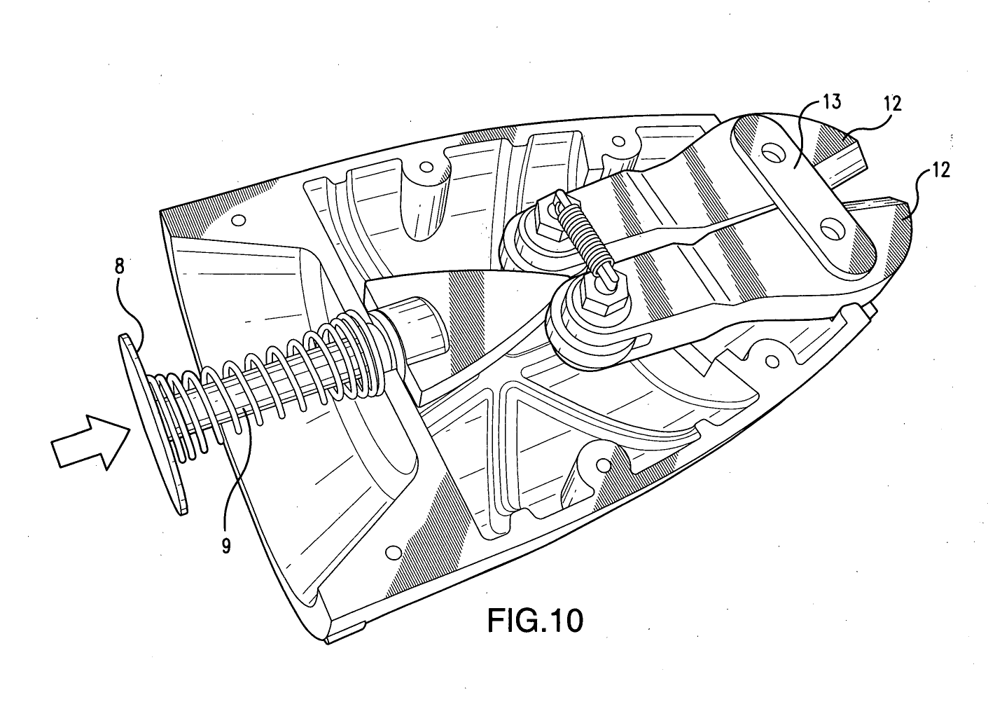

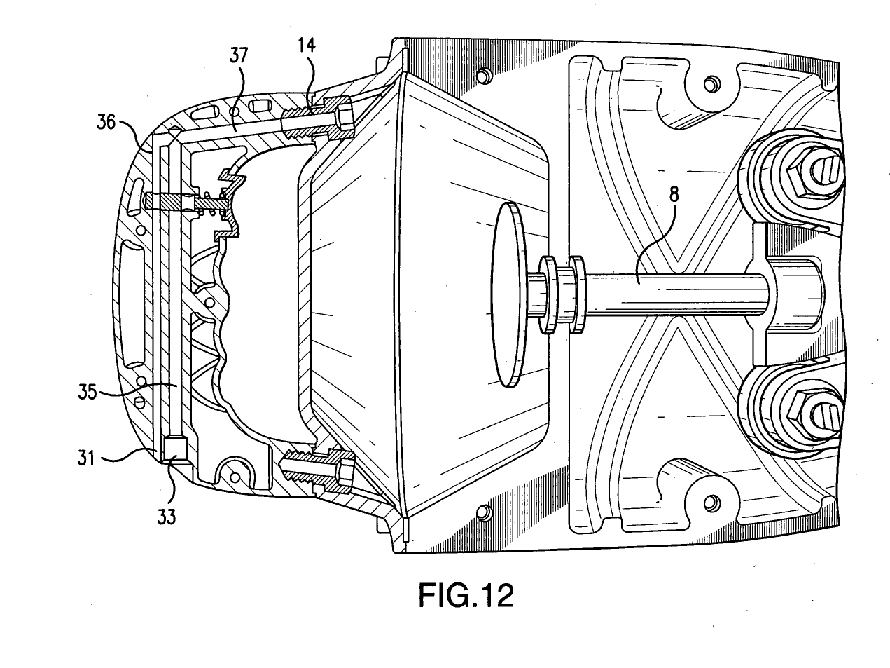

Once the bolt cutter has been fully cycled and is in the position shown in FIG. 11, the rod or bar would then be cut. At this point, the trigger 5 is released and compressed air in the chamber 41 is allowed to exhaust back through the cap screw 14, through passageway 37 and into the exhaust passageway 36 exiting the handle through orifice 34 as shown in FIG. 12. The combination of the piston spring 9 and the jaw springs 15 would force the jaws 12 open and the piston 8 back to the position shown in FIG. 10, thereby readying the bolt cutter for another cutting cycle.

Air exiting the screw 14 would enter into the chamber 41. Once the compressed air in the chamber spreads across the surface of the diaphragm 2, the increased pressure would force the diaphragm downward and therefore the piston 8 would begin moving toward the jaws 12 as shown in FIG. 10. The piston 8 would continue to move toward the jaws 12 until the entire gear cam 11 forces the proximal portion 45 of the jaw assembly apart, thereby forcing the jaws 12 together as illustrated in FIG. 11.

Those skilled in the art will appreciate that the concepts disclosed herein may readily inspire other embodiments fulfilling the objectives of the present invention. It is therefore intended that the claims be regarded as including such equivalent constructions insofar as they do not depart from the spirit and scope of the present invention.

What is claimed is:

1. A cutting device utilizing a source of compressed air, comprising:
a handle provided with an inlet removably connected to the source of compressed air, and at least one input passageway in fluid communication with said inlet;
a main body portion including a pair of laterally moving jaws extending from the distal end of said main body portion, said main body portion in fluid communication with said at least one input passageway provided in said handle, said main body portion further including a chamber receiving the compressed air therein and an actuation device provided between said chamber and said pair of laterally moving jobs for closing said pair of laterally moving jaws when the compressed air deflects a portion of said chamber, thereby moving said actuation device toward said pair of jaws, each of said jaws including a proximal portion as well as a distal portion provided with a cutting surface.

2. The cutting device in accordance with claim 1, wherein said actuation device includes a diaphragm forming the base of said chamber, a piston abutting said diaphragm and a gear cam connected to said piston, wherein when said diaphragm is deflected, said piston moves said gear cam between initially closed proximal portions of said jaws forcing the distal portion of said jaws together.

3. The cutting device in accordance with claim 2, further including a spring device connecting said proximal portions of said jaws together requiring said proximal portion of said jaws to be biased in the closed position and said distal portion of said jaws to be biased in the open position.

4. The cutting device in accordance with claim 3, wherein said gear cam includes a distal wedge portion and each of said proximal portions is provided with a roller bearing connected to said spring device, wherein when said wedge portion moves between each of said roller bearings to force said proximal portions of said jaws apart, said distal portions of said jaws would move toward one another.

5. The cutting device in accordance with claim 2, further including at least one output passageway in said handle and an outlet provided in said handle for exhausting the compressed air from said handle.

6. The cutting device in accordance with claim 5, further including a screw provided in said handle for transmitting the compressed air from said at least one input passageway to said chamber and for exhausting the compressed air from said chamber to said outlet passageway.

7. The cutting device in accordance with claim 6, further including a trigger extending from said handle, wherein when said trigger is depressed the compressed air flows through said at least one input passageway, but is prevented from flowing through said at least one outlet passageway.

8. The cutting device in accordance with claim 2, further including an end cap provided in said main body portion, said end cap and said diaphragm constituting said chamber.

9. The cutting device in accordance with claim 6, further including an end cap provided in said main body portion, said end cap and said diaphragm constituting said chamber, and further wherein the compressed air flows between said handle and said chamber through said screw.

10. The cutting device in accordance with claim 1, further including a pair of main body covers enclosing said main body portion.
